(19) United States
(12) Patent Application Publication
(10) Pub. No.: US 2015/0233163 A1
(43) Pub. Date: Aug. 20, 2015

(54) Folding door trolley

(71) Applicants: Julian Michael Svenson, Cornwall (CA); Craig McMartin, Ingleside (CA)

(72) Inventors: Julian Michael Svenson, Cornwall (CA); Craig McMartin, Ingleside (CA)

(21) Appl. No.: 14/544,689

(22) Filed: Feb. 3, 2015

(30) Foreign Application Priority Data
Feb. 14, 2014 (CA) 2842446

(51) Int. Cl. E05D 15/26

(52) U.S. Cl. CPC E05D 15/26

(57) ABSTRACT

A trolley for use with a folding door to suspend the door from an overhead track. The trolley has a mounting post for use in connecting the trolley to a folding door with a cylindrical mounting axle extending from the post. The trolley has a wheel unit comprising a short wheel axle with a wheel rotatably mounted at each end. The wheel unit is mounted on the post with the mounting axle on the post extending through the wheel axle between the wheels. The post is rotatable relative to the wheel unit.

### BACKGROUND OF THE INVENTION

1. Field of the Invention

The invention relates to a trolley for a folding door. A plurality of trolleys attached to the top of the folding door are used to suspend the door from an overhead track. The trolleys roll along the track and help the door to easily fold or unfold as required. The invention is also directed toward a folding door incorporating the trolleys.

2. Description of the Related Art

The prior art trolleys usually have a single wheel rotatably mounted on an axle. The axle is fixed to the top of a mounting post on the door, and extends from the post laterally relative to the direction the trolley travels. When the trolley is fixedly mounted on the top of a folding door, via the mounting post, the trolley wheel, offset to the side from the post, sits on an overhead track supporting the folding door off the ground. The door can often swing laterally to the side from the vertical plane it normally rests in while being opened or closed. Since the wheel axle is fixedly mounted to the trolley assembly and the trolley assembly is fixedly mounted to the door, if the door does swing laterally, the wheel will tilt and rub against a side of the track creating friction. The rubbing makes it harder to open or close the door and adds wear to the wheel. The door can also swing laterally while being moved around a curved section of track, centrifugal force swinging the door outwardly of the curve and tilting the trolley wheels on the curve inwardly to bear against the track, again making it harder to move the door.

### SUMMARY OF THE INVENTION

It is the purpose of the present invention to provide a trolley for a folding door which will reduce friction when the door swings laterally while being opened or closed. It is another purpose of the present invention to reduce the width of the trolley to allow closer stacking of the panels of a folding door when the door is folded, while reducing friction. It is another purpose of the present invention to provide a folding door with trolleys that reduces friction when the door swings laterally while being opened or closed. It is a further purpose of the present invention to provide a folding door with trolleys that allows the panels of the door to be folded more compactly.

In accordance with the present invention, a trolley is provided having a mounting post with a cylindrical mounting axle extending transversely from the top of the post. The trolley has a wheel unit consisting of a wheel axle with a wheel rotatably mounted at each end. The wheel unit is rotatably mounted on the mounting axle on the post with a wheel on each side of the axle. The wheel unit is mounted on a track with two spaced-apart running surfaces for the wheels with the post hanging from the unit between the running surfaces. The hanging post is fixed to a folding door. If the door swings laterally during folding or unfolding, the post rotates about the mounting axle with the wheels remaining on the running surfaces. The wheel unit is not tilted and thus the unit does not rub any walls while moving. Friction in moving the door is reduced. The door is easier to move. Wear on the wheels is also reduced. The trolley is relatively narrow compared to trolleys mounting the wheel laterally. The narrow trolleys permit the door panels to stack closer together when folded because the trolleys do not interfere with the door panels. Closer stacking can result in cost savings since less storage space is required to hold the folded closures.

The invention is particularly directed toward a trolley for use with a folding door to suspend the door from an overhead track. The trolley has a mounting post for use in connecting the trolley to a folding door and a cylindrical mounting axle extending from the top of the post. A wheel unit comprising a short wheel axle with a wheel rotatably mounted at each end is rotatably mounted on the mounting axle on the post, the mounting axle extending through the wheel axle between the wheels.

The invention is also directed to a folding door installation using the trolleys. The installation includes a folding door, an overhead track, and the trolleys of the present invention mounted on the top of the door and suspended from the track.

### BRIEF DESCRIPTION OF THE DRAWINGS

FIG. 1 is a perspective view of the trolley;

FIG. 2 is a side view of the post in the trolley;

FIG. 3 is a front view of the post in the trolley;

FIG. 4 is a top view of the post in the trolley;

FIG. 5 is a top view of the post with guide wheels;

FIG. 6 is a front view of the wheel unit in the trolley;

FIG. 7 is a side view, partly cut-away, of the trolley mounted in a folding door post; and

FIG. 8 is a cross-section view of a door trolley mounted in an overhead track.

### DESCRIPTION OF PREFERRED EMBODIMENT

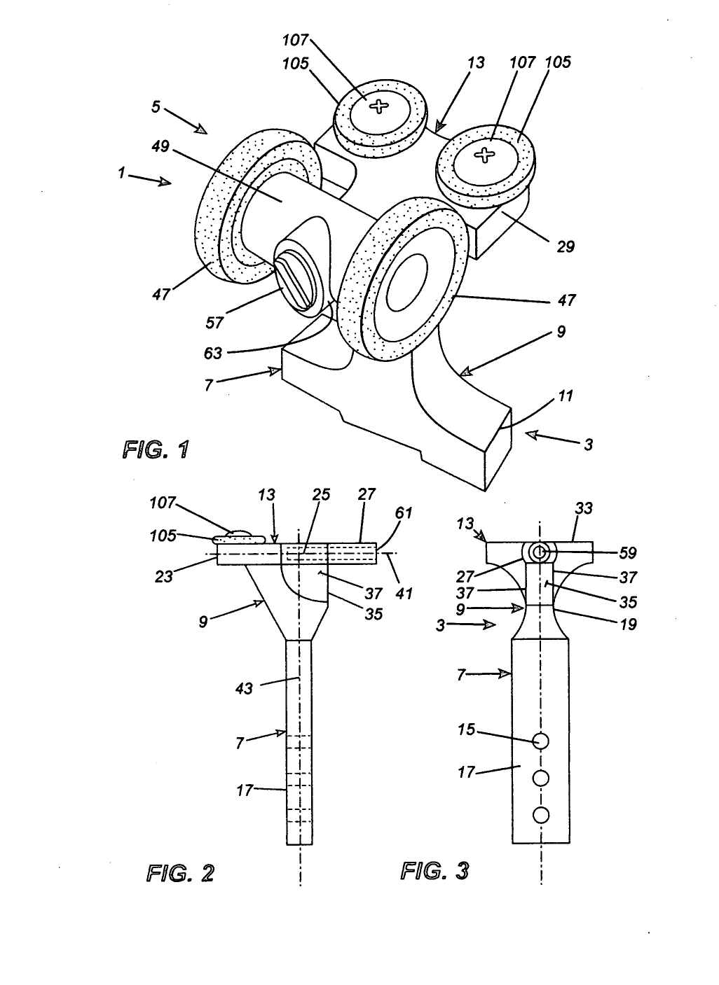

The trolley 1, as shown in FIGS. 1-5, has a mounting post 3 with a wheel unit 5 mounted on the top of the post 3. The mounting post 3 has an elongated stem 7 with a transition section 9 at the top 11 of the stem 7 joining the stem to the bottom of a plate-like cap 13. The cap 13 extends transverse to the stem 7. The stem 7 can have a rectangular cross-section with a series of spaced-apart, threaded, mounting holes 15 along its length extending between the wide sides 17 of the stem. The transition section 9 narrows down, moving up from the top 11 of the stem 7, to a thin neck area 19 and then widens again to substantially the width of the cap 13 before connecting to it. At the same time, the transition section 9 will thicken slightly both forwardly and rearward to become thicker than the stem before connecting to the bottom of the cap 13.

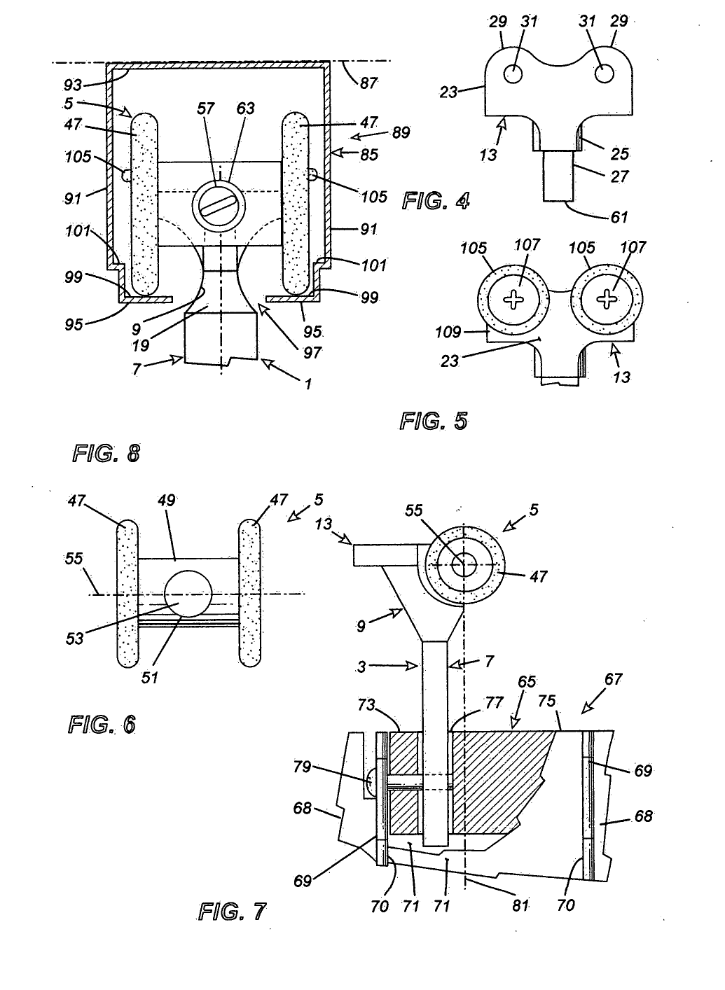

The cap 13 has a rear section 23 of slightly less width than the width of the track the trolley rides on, and a narrower front section 25 extending forwardly from the front of the rear section 23. The front section 25 is flat on top and partly rounded from the top down as shown in FIGS. 3 and 4. A cylindrical mounting axle 27 extends forwardly from the center of the front section 25. The rear corners 29 of the rear section 23 have mounting holes 31 extending down from the top 33 of the cap 13 through the section 23. The holes 31 are used to mount guide wheels on the top of the rear section 23 as will be described. The upper front portion of the transition section 9 is cut away on each side to provide a narrow front section 35 having flat parallel sides 37, the front section 35 about the width of the mounting axle 27 and directly below and behind the axle. The longitudinal axis 41 of the mounting axle 27 is perpendicular to the longitudinal axis 43 of the stem 7. The post 3 is a single molded unit with the stem 7, the transition section 9 and the cap 13 unitary.

The trolley 1 includes a wheel unit 5. The wheel unit 5, as shown in FIGS. 1 and 6, comprises a pair of wheels 47, one at each end of a short wheel axle 49. The wheel axle 49 has a cylindrical bore 51 extending transversely through it, the bore 51 centrally located between the wheels 47. The longitudinal axis 53 of the bore 51 is perpendicular to the longitudinal axis 55 of the wheel axle 49. The wheel unit 5 is mounted on the mounting axle 27 of the post 3, the mounting axle 27 passing snugly through the bore 51 in the wheel axle 49. The mounting axle 27 is slightly longer than the diameter of the wheel axle 49. The narrow front section 35 of the cap 13 permits the wheel unit 5 to be narrow allowing the folding door panels to stack together more closely. A screw or like fastener 57 can be threaded into a hole 59 in the free end 61 of the mounting axle 27 with a head or washer 63 large enough to retain the wheel unit 5 on the mounting axle 27 snugly between the fastener 57 and the front section 35 of the cap 13 on the mounting post 3. The mounting post 3, through its mounting axle 27 rotatably mounted in the wheel unit 5, can rotate relative to the wheel unit 5 about the longitudinal axis 41 of the mounting axle 27. The narrow front section 35 on the transition section 9 is spaced sufficiently from the wheels 47 to allow limited rotation of the post.

The trolley 1 is mountable on a support post 65, as shown in FIG. 7, in a folding door 67, only a section of which is shown. The support post 65 is mounted between two vertical panels 68, the panels connected to the support post by hinges 69. The support post 65 has two opposed end panels 70 joined by two opposed side panels 71. One or the other end panel 70 is a leading or front panel depending on which direction the post 65 travels. The support post 65 has a mounting block 73 at its top end 75 with a slot 77 in the block 73. The trolley 1 is mounted on the mounting block 73 by passing the stem 7 of the mounting post 3 through the slot 77. When the trolley 1 is mounted on the block 73, the mounting axle 27 on the mounting post 3 extends horizontally in a direction toward one of the end panels 70 of the support post 65. A threaded fastener 79 can be mounted through the block 73 to extend into the slot 77. The fastener 79 can be passed through one of the holes 15 in the stem 7, which holes are threaded, to retain the trolley 1 on the support post 65. The series of holes 15 in the stem 7 allows the height of the wheel unit 5 of the trolley 1 above the top end 75 of the support post 65 to be adjusted. The slot 77 is laterally offset from the longitudinal axis 81 of the support post 65 a distance to have the rotational axis 55 of the wheels 47 of the trolley 1 aligned with the longitudinal axis 81 of the support post 65 resulting in less stress applied to the wheel unit 5.

A track 85 for the trolleys 1 in the folding door is fastened to the top 87 of the opening 89 the door is to close as shown in FIG. 8. The track 85 has an inverted u-shape in cross-section with side walls 91 joined by a top wall 93. The top wall 93 of the track 85 is fastened to the top 87 of the opening 89 by suitable fastening means. The track 85 has wheel support flanges 95 extending inwardly toward each other from the bottom of the side walls 91 extending down from the top wall 93. A central gap 97 is provided between the wheel support flanges 95. The top of the flanges 95 provide running surfaces 99 for the wheels 47 on the trolley 1. With the wheels 47 on the running surfaces 99, the stem 7 of the post 3 of the trolleys 1 extends down to the door beneath the track 85, through the gap 97 between the flanges 95. The thin neck area 19 of the post 3 is aligned with the flanges 95, the neck area narrower than the gap 97 between the flanges 95.

The side walls 91 of the track 85 may have narrow shoulders 101 extending part way up from the bottom of the side walls 91 to limit contact the wheels 47 of the trolley 1 may make with the side walls 91. Only a small part of the wheels 47 would contact the shoulders 101 if the wheel unit 5 moves slightly sideways in the track 85. The post 3 can also carry guide means on the cap 13 as shown in FIG. 5. The guide means 32 can comprise two small disks 105, one each mounted adjacent a rear corner 29 of the cap 13. The disks 105 rest flat on the top 33 of the cap 13 and are rotatable about fastening means 107 connecting them to the cap 13. The fastening means 107, such as a screw, use the mounting holes 31 in the cap. Each disk 105 extends slightly past the side 109 of the cap 13 to be adjacent a side wall 91 of the track 85. If the wheel unit 5 has a tendency to move laterally while the door is being moved, the disk 105 on the side the unit 5 moves toward will contact and rotate against the side wall 91 of the track 85 to limit contact of the wheels 47 with the side walls 91.

The neck area 19 and the narrow front portion 35 of the transition section 9 provide room for the wheels 47 to be closely adjacent the longitudinal axis 43 of the stem 7 making the unit very compact. Even though the wheel unit 5 is compact, the shaping of cap 13 and the transition section 9 to provide a narrow front potion 35 with flat sides 37 provides room for the post 3, and thus the attached door, to swing about the mounting axle 27 on the wheel unit 5 in the track 85 without normally encountering the wheels 47. Thus the wheel unit 5 normally stays square on the running surfaces 99 instead of tilting into the walls 91.

The above description is meant to be exemplary only, and one skilled in the art will recognize that changes may be made to the embodiments described without departing from the scope of the invention disclosed. Modifications which fall within the scope of the present invention will be apparent to those skilled in the art. In light of a review of this disclosure, such modifications are intended to fall within the appended claims.

I claim:

1. A trolley for use with a folding door to suspend the door from an overhead track, the trolley having: a mounting post for use in connecting the trolley to a folding door; a cylindrical mounting axle extending from the top of the post; a wheel unit comprising a short wheel axle with a wheel rotatably mounted at each end; the wheel unit rotatably mounted on the mounting axle on the post, the mounting axle extending through the wheel axle between the wheels.

2. A trolley as claimed in claim 1 wherein the mounting post has an elongate stem and a cap at the top of the stem, the mounting axle extending from one end of the cap transverse to the stem.

3. A trolley as claimed in claim 2 wherein the cap is joined to the stem with a neck that is substantially narrower than the stem or cap.

4. A trolley as claimed in claim 2 wherein the cap has a wide section and a narrow section extending from a side of the wide section, the mounting axle extending from the free end of the narrow section of the cap.

5. A trolley as claimed in claim 2 having a transition section joining the stem to the bottom of the cap, the transition section having a narrow neck joining it to the top of the stem, and an enlarged section that enlarges from the top of the neck to the bottom of the cap, the enlarged section cut away at the front to form a narrow front section just below and behind the mounting axle.

6. A trolley as claimed in claim 2 wherein the top of the cap has a disk at each of the two corners of the cap farthest from the mounting axle, each disk adjacent the top of cap and rotatably attached thereto, each disk extending slightly past the side of the cap.

7. A trolley for use with a folding door to suspend the door from an overhead track, the trolley having;
a mounting post; the post having an elongate stem for use in connecting the trolley to a folding door and a cylindrical mounting axle above the stem extending perpendicular to the stem;
a wheel unit; the wheel unit having a short wheel axle with a wheel rotatably mounted at each end; the wheel axle having a cylindrical bore extending through it between the wheels, the longitudinal axis of the bore transverse to, and intersecting, the longitudinal axis of the wheel axle;
the wheel unit rotatably mountable on the mounting post with the mounting axle extending snugly through the bore on the wheel axle, the post rotatable relative to the wheel unit about the longitudinal axis of the bore in the wheel axle.

8. A trolley as claimed in claim 7 wherein the mounting post has a cap at the top extending transverse to the stem, the mounting axle extending from one end of the cap.

9. A trolley as claimed in claim 8 wherein the cap is joined to the stem with a transition section that has a narrow neck.

10. A trolley as claimed in claim 7 wherein the post has a cap at the top extending transverse to the stem, the cap having a wide section and a narrow section, the mounting axle extending from the narrow section of the cap, the wheels on the wheel unit on either side of, and adjacent to, the narrow section of the cap.

11. A trolley as claimed in claim 10 wherein the mounting post has a transition section between the top of the stem and the bottom of the cap, the transition section having a narrow neck, the transition section having a narrow front section beneath the narrow end of the cap and above the neck, the front section having flat parallel sides spaced inwardly from the wheels to allow the post rotational movement about the mounting axle.

12. A trolley as claimed in claim 8 wherein the top of the cap has a disk at each corner of the wide end of the cap, each disk adjacent the top of cap and rotatably attached thereto, each disk extending slightly past the side of the cap.

13. A folding door having at least one vertical support post with at least one door panel hingedly attached to the post, the support post having opposed end walls, one end wall facing one direction the post travels, the other end wall facing the opposite direction the post travels, a trolley mounted on top of the post, the trolley having a mounting post for insertion into the top of the support post and a cylindrical mounting axle extending perpendicularly from the top of the mounting post, the mounting axle pointing at the center of one of the end walls;
a wheel unit having a wheel axle with a rotatable wheel at each end of the axle, a cylindrical bore extending transversely through the wheel axle between the wheels;
the wheel unit rotatably mounted on the mounting post by inserting the mounting axle on the post snugly through the bore in the wheel axle, and retaining means cooperating with the end of the wheel axle to retain the wheel unit on the mounting post with the wheel axle transverse to, and laterally offset, from the longitudinal axis of the post.

14. A folding door installation having;
a folding door with at least one vertical support post, the support post having a vertical slot extending down from its top end;
a trolley having a mounting post insertable part way into the slot in the support post and a mounting axle at the top of the mounting post extending perpendicular from the mounting post and pointing in a direction the support post travels;
the trolley having a wheel unit with a wheel axle with a wheel at each end, and a bore through the center of the wheel axle between the wheels to receive the mounting axle on the mounting post,
a u-shaped track mounted in an inverted position at the top of the opening the folding door is to close, the track having side walls extending downwardly from a top wall, and an inwardly extending flange at the end of each side wall, the flanges defining a gap between them,
the trolley mounted with the wheel unit within the track with a wheel on each flange and with the mounting post extending through the gap.

15. A folding door installation as claimed in claim 14 wherein the slot in the support post is offset, in the direction the post travels, from the longitudinal center of the support post a distance sufficient to have the longitudinal center of the support post aligned with the longitudinal axis of the wheel axle.
